(19) United States
(12) Patent Application Publication
(10) Pub. No.: US 2020/0102526 A1
(43) Pub. Date: Apr. 2, 2020

(54) WIPES FOR COATING SURFACES AND METHODS

(71) Applicant: 3M INNOVATIVE PROPERTIES COMPANY, St. Paul, MN (US)

(72) Inventors: Zachary J. Malmberg, Roseville, MN (US); Robert A. Schmitz, Minneapolis, MN (US); Robert J. Maki, Hudson, WI (US); Michael S. Krasky, Cottage Grove, MN (US)

(21) Appl. No.: 16/589,310

(22) Filed: Oct. 1, 2019

Related U.S. Application Data
(60) Provisional application No. 62/739,715, filed on Oct. 1, 2018.

(51) Int. Cl. C11D 17/04; C11D 3/16; C11D 3/36; C11D 3/08; C11D 11/00

(52) U.S. Cl. CPC C11D 17/049; C11D 3/162; C11D 11/0029; C11D 3/362; C11D 3/08; C11D 3/361

(57) ABSTRACT

The present disclosure is directed to wipes that include aqueous compositions and methods for coating, particularly protecting and optionally cleaning, surfaces, particularly metallic surfaces.

### BACKGROUND

Stainless steel is ubiquitous in commercial kitchens, home kitchens, office buildings, airports, and various other public spaces. The majority of cleaning products designed for use on stainless steel surfaces are both cleaners and polishers (including mixtures of mineral oil and water, or solvent and mineral oil). The oil in these products helps hide fingerprints by blending/covering them with the applied mineral oil. The oily layer provides the substrate a shiny appearance.

Stainless steel products that utilize this clean and polish approach typically suffer from many drawbacks, including: streaking (e.g., it is difficult to get a streak-free shine); difficult to “spot clean” a portion of the surface (e.g., users typically have to clean an entire area to maintain a uniform oil layer); the product dries slowly, and the appearance changes during drying; attraction to dirt (e.g., oiled surfaces collect lint and dust easily); oil build-up (e.g., mineral oil left on surfaces can accumulate and is difficult to remove); and the inability to cut tough stains commonly found in restrooms.

Thus, there is a need for wipes that include compositions that can coat, and more particularly protect, and optionally clean and protect, stainless steel surfaces, and other surfaces, particularly other metallic surfaces.

### SUMMARY

The present disclosure addresses this challenge. The present disclosure is directed to wipes that include aqueous compositions and methods for coating, and more particularly protecting, and optionally cleaning and protecting, surfaces, particularly metallic surfaces.

Advantageously, in certain embodiments, wipes of the present disclosure protect metallic surfaces, thereby making them easier to subsequently clean. In certain embodiments, wipes of the present disclosure clean and protect surfaces, particularly metallic surface (in one step). The wipes include aqueous compositions that include a silicate, a non-zwitterionic anionic silane, and a zwitterionic silane.

In one embodiment, the present disclosure provides a wipe including a fibrous substrate and an aqueous composition impregnated therein, wherein: the fibrous substrate that includes oleophilic fibers and hydrophilic fibers in amounts within a weight ratio range of 10:90 to 90:10; and the aqueous composition includes: greater than 0 wt-% and up to 50 wt-% of a silicate; a non-zwitterionic anionic silane; a zwitterionic silane; and water; wherein the weight percent of silicate is based on the total weight of silane(s) plus silicate(s) solids in the composition.

In one embodiment, the present disclosure provides a method of coating a surface, the method including: providing a wipe as described herein; applying the aqueous composition of the wipe to the surface; and allowing the aqueous composition to dry on the surface. In certain embodiments, the method is a method of cleaning and protecting a surface and applying the aqueous composition includes applying the aqueous composition to the surface under conditions effective to remove contaminants from the surface.

### DEFINITIONS

In the context of a composition, “solids” or “total solids” refers to the amount of solids, without a liquid carrier, unless specified otherwise.

In the context of a coating, a “hardened” coating refers to one that is dried upon removal of the water and optional organic solvents. The components of the coating form a network of silane(s) plus silicate(s) that are bonded together chemically and/or physically, including ionic bonding, hydrogen bonding, and/or covalent bonding.

Herein, a “metallic surface” refers to a surface that includes elemental metals or alloys of metals. The term also includes surface oxides of such elemental metal or alloy. This term does not include bulk oxides, such as alumina, silica, etc.

In the context of a surface, a “hydrophilic” surface is one that is wet by aqueous solutions, and does not express whether or not the layer absorbs aqueous solutions. Surfaces on which drops of water or aqueous solutions exhibit an advancing water contact angle of less than 45° are referred to as “hydrophilic” per ASTM D7334-08.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. For example, a composition that includes “a” surfactant may include “one or more” surfactants.

As used herein, the term “or” is generally employed in its sense including “and/or” unless the content clearly dictates otherwise. The term “and/or” means one or all of the listed elements or a combination of any two or more of the listed elements.

As used herein, all numbers are assumed to be modified by the term “about” and in certain embodiments by the term “exactly.” Notwithstanding that the numerical ranges and parameters setting forth the broad scope of the invention are approximations, the numerical values set forth in the specific examples are reported as precisely as possible. All numerical values, however, inherently contain certain errors necessarily resulting from the standard deviation found in their respective testing measurements.

Also herein, the recitations of numerical ranges by endpoints include all numbers subsumed within that range (e.g., 1 to 5 includes 1, 1.5, 2, 2.75, 3, 3.80, 4, 5, etc.). Herein, “up to” a number (e.g., up to 50) includes the number (e.g., 50).

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

When a group is present more than once in a formula described herein, each group is “independently” selected, whether specifically stated or not. For example, when more than one Y group is present in a formula, each Y group is independently selected. Furthermore, subgroups contained within these groups are also independently selected. For example, when each Y group contains an R, then each R is also independently selected.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated, linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkylene group” is a divalent alkyl group. The term “alkenyl group” means an unsaturated, linear or branched hydrocarbon group with one or more carbon-carbon double bonds, such as a vinyl group. The term “alkynyl group” means an unsaturated, linear or branched hydrocarbon group with one or more carbon-carbon triple bonds. The term “cyclic group” means a closed ring hydrocarbon group that is classified as an alicyclic group, aromatic group, or heterocyclic group. The term “alicyclic group” means a cyclic hydrocarbon group having properties resembling those of aliphatic groups. The term “aromatic group” or “aryl group” means a mono- or polynuclear aromatic hydrocarbon group. The term “heterocyclic group” means a closed ring hydrocarbon in which one or more of the atoms in the ring is an element other than carbon (e.g., nitrogen, oxygen, sulfur, etc.). A group that may be the same or different is referred to as being “independently” something. Unless otherwise specified herein, all such groups typically have 100 or fewer carbon atoms, and often 50 or fewer carbon atoms.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### DETAILED DESCRIPTION OF ILLUSTRATIVE EMBODIMENTS

The present disclosure is directed to wipes that include aqueous compositions and methods for coating, more particularly protecting, and optionally cleaning and protecting, surfaces, particularly metallic surfaces, and articles containing such surfaces, particularly those in a kitchen, for example.

Typically, the aqueous compositions are delivered to a surface by toweling or rubbing the wipe in a manner that allows at least a portion of the composition to spread and coat the surface.

Thus, the present disclosure provides a method of coating a surface, the method including: providing a wipe that includes a fibrous substrate and an aqueous composition impregnated therein; applying the aqueous composition to the surface; and allowing the aqueous composition to dry on the surface. In certain embodiments, such a method is a method of cleaning and protecting a surface, wherein applying the aqueous composition includes applying the aqueous composition to the surface under conditions effective to remove contaminants from the surface.

For cleaning a surface, contaminants (e.g., oily residue) may be removed by wiping, or scrubbing as needed. Aqueous compositions may be dried and hardened (and optionally cured) by simply letting the water evaporate, or by the application of heat, radiation, or a combination thereof.

In certain embodiments, the surface is a metallic surface or a ceramic surface. In certain embodiments, the surface is a metallic surface. Metallic surfaces refer to those surfaces that include elemental metals or alloys of metals and/or surface oxides of such metallic surfaces. Examples include stainless steel, aluminum, anodized aluminum, copper, titanium, zinc, silver, a surface oxide thereof, or combinations thereof (such as alloys, e.g., brass). In certain embodiments, the metallic surface includes stainless steel, aluminum, anodized aluminum, a surface oxide thereof, or a combination thereof.

The present disclosure also provides methods of coating articles that include a metallic or ceramic surface, particularly a metallic surface, using a wipe as disclosed herein. Examples of such articles include those in a home or commercial kitchen (e.g., refrigerator, dishwasher, stove, oven, microwave, exhaust hoods, fryers, grease traps, food-preparation tables, cabinets), or in a restroom (e.g., toilet stall partitions, urinal partitions). Examples of such articles also include decorative or functional wall cladding such as in/on an elevator or escalator, walls in airports, hospitals, subway stations, train stations, malls, or in other commercial buildings. Examples of such articles also include decorative or functional panels in an automobile (e.g., decorative metallic parts in a car interior). Examples of such articles include consumer electronics, such as metal cases for electronic article (e.g., phones, tablets, and computers). Examples of such articles also include manufacturing equipment and tools.

In certain embodiments, such surfaces and articles include a hardened coating disposed thereon, wherein the hardened coating includes: a silicate; a non-zwitterionic anionic silane; and a zwitterionic silane; wherein the hardened coating is attached to the surface associatively, and is hydrophilic (i.e., with an advancing water contact angle of less than 45 degrees, or preferably less than 30 degrees, or less than 10 degrees). A typical hardened coating is less than 1000 nm thick, or less than 500 nm thick, or less than 200 nm thick, or less than 100 nm thick, or less than 50 nm thick, or less than 10 nm thick.

In certain embodiments, wipes of the present disclosure demonstrate fingerprint removal of at least 75%, at least 90%, or at least 100%, after 5 testing cycles according to the Fingerprint Removal Test With Wipe Media Application described in the Examples Section. In certain embodiments, wipes of the present disclosure demonstrate oil removal of at least 75%, at least 90%, or at least 100%, after 5 testing cycles according to the Vegetable Oil Removal Test With Wipe Media Application described in the Examples Section.

Fibrous substrates are selected according to their fiber composition and basis weight to provide a wipe with sufficient absorption and holding capacity of the aqueous composition (as demonstrated by water alone). In certain embodiments, fibrous substrates are selected to have a water absorption ratio of at least 9 grams (or at least 10 grams, or at least 10.5 grams) water to 1 gram substrate. Alternatively stated, fibrous substrates are selected to demonstrate total water absorbed in an amount of at least 300 grams (or at least 400 grams) per square meter of fibrous substrate. In certain embodiments, fibrous substrates are selected to have as high a water absorption ratio, or total water absorbed, as possible. From a practical perspective, a ratio as high as 12 grams water to 1 gram substrate, or a total amount of absorbed water as high as 1000 grams water absorbed per square meter of substrate, may be sufficient. Such water absorption ratios and total water absorbed can be determined according to the Water Absorption Test described in the Examples Section.

Fibrous substrates are selected according to their fiber composition and basis weight to provide a wipe with sufficient absorption and removal of contaminants (as demonstrated by oil). In certain embodiments, fibrous substrates are selected to have an oil absorption ratio of at least 9 grams (or at least 10 grams, or at least 10.5 grams) oil to 1 gram substrate. Alternatively stated, fibrous substrates are selected to demonstrate total oil absorbed in an amount of at least 200 grams (or at least 300 grams) per square meter of fibrous substrate. In certain embodiments, fibrous substrates are selected to have as high an oil absorption ratio, or total oil absorbed, as possible. From a practical perspective, a ratio as high as 17 grams oil to 1 gram substrate, or a total amount of absorbed oil as high as 1100 grams oil absorbed per square meter of substrate, may be sufficient. Such oil absorption ratios and total oil absorbed can be determined according to the Oil Absorption Test described in the Examples Section.

### Wipes and Substrates

A wipe (e.g., a towelette or absorbent sheet) of the present disclosure includes a substrate and an aqueous composition impregnated therein.

Such fibrous substrate can be a knit, woven, or nonwoven material. The fibers can be distributed haphazardly or in random array, or substantially aligned. The fibers can be “oriented” or carded into fibrous webs, the major proportion of which are oriented predominantly in one direction. Thermoplastic fibers can be formed into thermocarded nonwoven webs, which can be spun bonded (i.e., the fibers are spun out onto a flat surface and bonded/melted together by heat or chemical reactions).

The fibers of the fibrous substrate can be thermally or adhesively bonded together, as is known to one of skill in the art.

The fibers of the fibrous substrate may be staple fibers or continuous fibers.

In certain embodiments, the fibers of the fibrous substrate may have diameters ranging from 10 microns to 50 microns.

The fibers of the fibrous substrate can be natural (e.g., wool, silk, jute, hemp, cotton, linen, sisal, or ramie) or synthetic (e.g., rayon, cellulose ester, polyvinyl derivatives, polyolefins, polyamides, or polyesters).

The fibrous substrate includes a mixture of oleophilic fibers and hydrophilic fibers in amounts within a weight ratio range of 10:90 to 90:10, within a weight ratio range of 20:80 to 80:20, within a weight ratio range of 30:70 to 70:30, within a weight ratio range of 40:60 to 60:40, or in amounts of 50:50. In this context, oleophilic refers to fibers that exhibit a static water contact angle of greater than 45 degrees and hydrophilic refers to fibers that exhibit a static water contact angle less than 45 degrees. Suitable fibers are those that possess these static contact angle values when in their typical manufactured state without modification via, e.g., corona treatment, plasma treatment, or the like.

Examples of hydrophilic fibers include cellulose fibers, rayon fibers (viscose, modal, and lyocell fibers), cotton fibers, polyamide fibers, polyacrylic acid fibers, fibers treated with surfactant (e.g., anionic, cationic, nonionic, or zwitterionic), or combinations thereof.

Examples of oleophilic fibers include polyurethane fibers, polypropylene fibers, polyethylene fibers, polyethylene terephthalate fibers, or combinations thereof.

Suitable substrates have a wide mass per area. In certain embodiments, the substrate mass per area is at least 20 grams per square meter (g/m² or gsm), at least 30 gsm, at least 40 gsm, at least 50 gsm, at least 60 gsm, or at least 70 gsm. In certain embodiments, the substrate mass per area is up to 140 gsm, up to 130 gsm, up to 120 gsm, up to 110 gsm, or up to 100 gsm.

An aqueous composition as described herein may be applied to a substrate by coating onto, or impregnating into, one or both sides of a fibrous substrate.

It is preferred to employ substrates with a high absorbent capacity. The absorbent capacity of a substrate is the ability of the substrate, while supported horizontally, to hold liquid. In certain embodiments, an aqueous composition is present in an amount of at least 2 grams composition per gram wipe, at least 3 grams composition per gram wipe, or at least 3.5 grams composition per gram wipe. In certain embodiments, an aqueous composition is present in an amount of up to 6 grams composition per gram wipe, or up to 5.5 grams composition per gram wipe.

### Aqueous Compositions

Aqueous compositions used in wipes of the present disclosure include a silicate, a non-zwitterionic anionic silane, a zwitterionic silane, and water. Depending on the use, aqueous compositions used in the wipes of the present disclosure may also include a surfactant and/or other optional components, such as an organic solvent, an alkalinity source, a water conditioning agent, a bleaching agent, and other optional additives (e.g., dyes, fragrances, corrosion inhibitors, enzymes, and/or thickeners).

Aqueous compositions used in wipes of the present disclosure may be used for coating a surface, particularly a metallic surface (e.g., a metal surface and/or a metal oxide surface). In certain embodiments, they may be used for cleaning and protecting a surface, particularly a metallic surface, in one step.

Aqueous compositions used in wipes of the present disclosure may provide one or more of the following advantages: (1) the resultant coated surfaces attract less dirt (e.g., fingerprints, vegetable oil) than control or non-coated surfaces; (2) when dirt does collect, the coated surfaces can be more easily cleaned (e.g., using a simple wet cloth, water wash, or water dipping depending upon the harshness of the grime); and (3) the coated surfaces may not display an unsightly chalky residue from build-up of the coating.

As used herein, the term “aqueous composition” refers to compositions containing water. Such compositions are typically solutions and may employ water as the only solvent or liquid carrier, or they may employ combinations of water and organic solvents such as alcohol and acetone to improve, for example, freeze-thaw stability.

In some embodiments, aqueous compositions (i.e., “compositions” or “coating compositions”) used in wipes of the present disclosure include water in an amount of at least 80 weight percent (wt-%), and often at least 90 wt-%, based on the total weight of the composition.

In some embodiments, aqueous compositions used in wipes of the present disclosure include solids (e.g., the silane(s) and silicate(s) without their liquid carriers) in an amount of up to 20 wt-%, or up to 10 wt-%, or up to 8 wt-%, or up to 6 wt-%, or up to 4 wt-%, or up to 2 wt-%, or up to 1 wt-%, or up to 0.1 wt-%, or up to 0.001 wt-%, based on the total weight of the composition.

Aqueous compositions used in wipes of the present disclosure may be provided in a variety of viscosities. At standard conditions, preferred compositions have a viscosity less than 500 centipoise, less than 200 centipoise, less than 100 centipoise, less than 50 centipoise, less than 20 centipoise, or less than 10 centipoise. Such lower viscosity formulations wick quickly into a stack of dry precut wipes, enabling the high speed production of wipes of this disclosure. Additionally, such compositions allow for practical use of the wipes by allowing the liquid component to freely transfer from the wipe to the surface intended to be contacted. High viscosity compositions may lessen the exchange rate of the solution and soils between the wipe and the surface being cleaned.

### Silicates

Aqueous compositions used in wipes of the present disclosure include one or more silicates, which may provide enhanced durability to a coating through crosslinking, thereby providing protection to a surface, particularly a metallic surface. Suitable silicates may be inorganic or organic silicates, or combinations thereof.

Examples of suitable inorganic silicates include lithium silicate, sodium silicate, potassium silicate, or combinations thereof. Lithium silicate is a preferred silicate.

Examples of suitable organic silicates include tetraalkoxysilane (e.g., tetraethylorthosilicate (TEOS)) and oligomers thereof such as alkyl polysilicates (e.g., poly(diethoxysiloxane)).

In some embodiments, aqueous compositions used in wipes of the present disclosure include a silicate in an amount of greater than 0 weight percent (wt-%), or at least 1 wt-%, or at least 5 wt-%, or at least 10 wt-%, or at least 15 wt-%, or at least 20 wt-%, or at least 25 wt-%, or at least 30 wt-%, based on the total weight of silane(s) and silicate(s) solids (i.e., without the liquid carrier(s)) in the composition. In some embodiments, aqueous compositions used in wipes of the present disclosure include a silicate in an amount of up to 50 wt-%, or up to 45 wt-%, or up to 40 wt-%, or up to 35 wt-%, based on the total weight of silicate(s) plus silane(s) solids (i.e., without the liquid carrier(s)) in the composition.

### Non-Zwitterionic Anionic Silanes

Aqueous compositions used in wipes of the present disclosure include one or more non-zwitterionic anionic silanes. Non-zwitterionic anionic silanes (i.e., silanes without electrical charges of opposite sign within a molecule) include those with associative functional groups that adhere to a surface, particularly a metallic surface.

Associative functional groups provide associative bonding of the coating to the surface, particularly a metallic surface. Such associative bonding includes chelating bonding modes, thereby attaching a hardened coating to a surface, particularly a metallic surface, associatively. As shown in FIG. 12 of Angew. Chem. Int. Ed. 2014, 53, 6322-6356, which is reproduced below, the binding modes of exemplary phosphonic acid functional groups to a metal oxide surface (M) are shown, including monodentate (a and b), bridging bidentate (c and d), bridging tridentate (e), chelating bidentate (f and g), chelating tridentate (h), and additional hydrogen-bonding interactions (i-1).

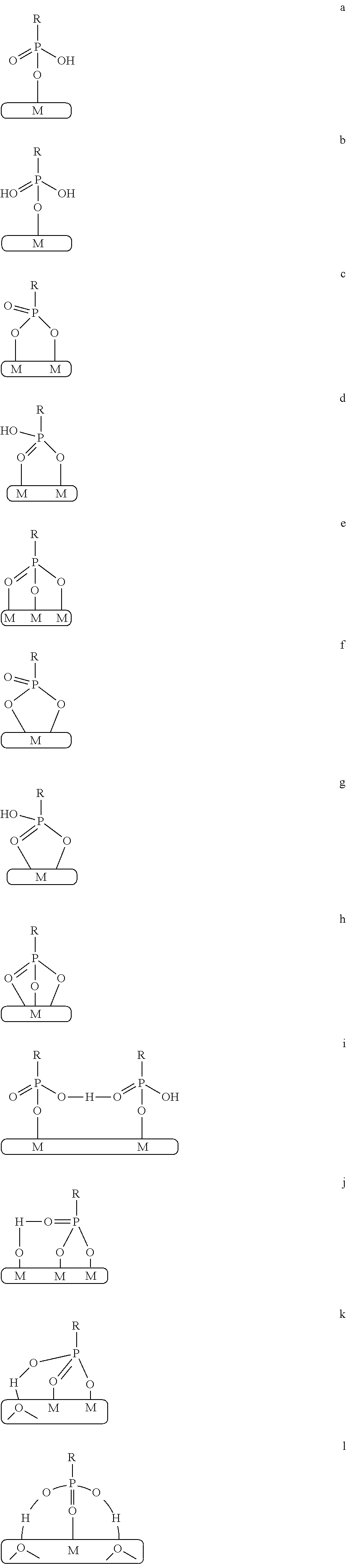

Thus, these compounds are used in aqueous compositions used in wipes of the present disclosure as adhesion promoters to a surface, particularly a metallic surface.

Examples of such non-zwitterionic anionic silanes include a non-zwitterionic sulfonate-functional silane, a non-zwitterionic carboxylate-functional silane, a non-zwitterionic phosphate-functional silane, a non-zwitterionic phosphonic acid-functional silane, a non-zwitterionic phosphonate-functional silane, or a combination thereof.

In certain embodiments, the non-zwitterionic anionic compounds used in the aqueous compositions used in wipes of the present disclosure have the following Formula (I):

[(MO)(Q²)ₙSi(XCH₂V^{t-})₃₋ₙ]Y_{2/nr}_{^{+r}} (I)

wherein:

each Q² is independently selected from hydroxyl, alkyl groups containing from 1 to 4 carbon atoms, and alkoxy groups containing from 1 to 4 carbon atoms;

M is selected from hydrogen, alkali metals, and organic cations of strong organic bases having an average molecular weight of less than 150 and a pKa of greater than 11;

X is an organic linking group;

V^{t-} is —SO₃⁻, —CO₂⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group (preferably having 20 carbons or less, more preferably R is aliphatic having 20 carbons or less, and even more preferably R is methyl, ethyl, propyl, or butyl);

Y is selected from hydrogen, alkaline earth metals (e.g., magnesium, calcium, etc.), organic cations of protonated weak bases having an average molecular weight of less than 200 and a pKa of less than 11 (e.g., 4-aminopyridine, 2-methoxyethylamine, benzylamine, 2,4-dimethylimidazole, 3-[2-ethoxy(2-ethoxyethoxy)]propylamine), alkali metals, and organic cations of strong organic bases having an average molecular weight of less than 150 and a pKa of greater than 11 (e.g., ⁺N(CH₃)₄, ⁺N(CH₂CH₃)₄), provided that M is hydrogen when Y is selected from hydrogen, alkaline earth metals and organic cations of said protonated weak bases;

r is equal to the valence of Y; and

n is 1 or 2.

Preferably, the non-zwitterionic anionic compound of Formula (I) is an alkoxysilane compound (e.g., wherein Q² is an alkoxy group containing from 1 to 4 carbon atoms).

The weight percentage of oxygen in these compounds of Formula (I) is at least 30%, or at least 40%. Preferably, it is in the range of 45% to 55%. The weight percentage of silicon in these compounds is no greater than 15%. Each of these percentages is based on the weight of the compound in the water-free acid form.

In certain embodiments, the organic linking group X of Formula (I) may be selected from alkylene groups, cycloalkylene groups, alkyl-substituted cycloalkylene groups, hydroxy-substituted alkylene groups, hydroxy-substituted mono-oxa alkylene groups, divalent hydrocarbon groups having mono-oxa backbone substitution, divalent hydrocarbon groups having mono-thia backbone substitution, divalent hydrocarbon groups having monooxo-thia backbone substitution, divalent hydrocarbon groups having dioxo-thia backbone substitution, arylene groups, arylalkylene groups, alkylarylene groups and substituted alkylarylene groups. Preferably, X is selected from alkylene groups, hydroxy-substituted alkylene groups and hydroxy-substituted mono-oxa alkylene groups.

Sulfonate-functional silane compounds have an alkoxysilane- and/or silanol-functional group (which can bond to a substrate surface) and a sulfonate group (—SO₃⁻) (which can render a substrate surface hydrophilic). Examples include non-zwitterionic sulfonate-functional silane compounds such as those disclosed in U.S. Pat. No. 4,152,165 (Langager et al.) and U.S. Pat. No. 4,338,377 (Beck et al.), and include, for example, the following:

(HO)₃Si—CH₂CH₂CH₂—O—CH₂—CH(OH)—CH₂SO₃⁻H⁺;

(HO)₃Si—CH₂CH(OH)—CH₂SO₃⁻H⁺;

(HO)₃Si—CH₂CH₂CH₂SO₃⁻H⁺;

(HO)₃Si—C₆H₄—CH₂CH₂SO₃⁻H⁺;

(HO)₂Si—[CH₂CH₂SO₃⁻H⁺]₂;

(HO)—Si(CH₃)₂—CH₂CH₂SO₃⁻H⁺;

(NaO)(HO)₂Si—CH₂CH₂CH₂—O—CH₂—CH(OH)—CH₂SO₃⁻Na⁺; and

(HO)₃Si—CH₂CH₂SO₃⁻K⁺.

Phosphonate-functional silane compounds have an alkoxysilane- and/or silanol-functional group (which can bond to a substrate surface) and a phosphonate group (—OP(═O)(R)O⁻, wherein R can be aliphatic, aromatic, branched, linear, or cyclic, or heterocycle) (which can render a substrate surface hydrophilic). Examples include non-zwitterionic phosphonate-functional silane compounds, such as those commercially available from multiple vendors, including, for example, Dow and Gelest. In certain embodiments, the non-zwitterionic phosphonate-containing compounds used in compositions of the present disclosure include:

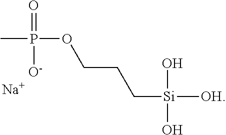

Carboxylate-functional silane compounds have an alkoxysilane- and/or silanol-functional group (which can bond to a substrate surface) and a carboxylate group (—CO₂⁻) (which can render a substrate surface hydrophilic). Examples include non-zwitterionic carboxylate-functional silane compounds, such as those commercially available from multiple vendors, including, for example, Dow and Gelest. In certain embodiments, the non-zwitterionic carboxylate-containing compounds used in compositions of the present disclosure include:

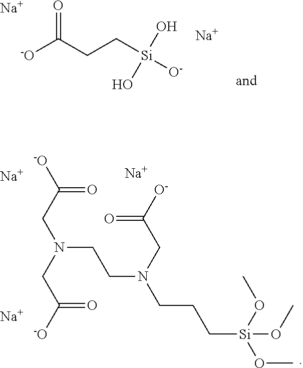

Phosphate-functional silane compounds have an alkoxysilane- and/or silanol-functional group (which can bond to a substrate surface) and a phosphate group (—OPO₃²) (which can render a substrate surface hydrophilic). In certain embodiments, the non-zwitterionic phosphate-containing compounds used in compositions used in wipes of the present disclosure include:

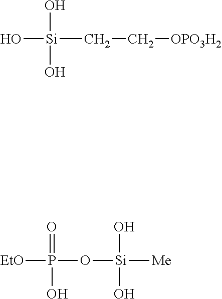

Phosphonic acid-functional silane compounds have an alkoxysilane- and/or silanol-functional group (which can bond to a substrate surface) and a phosphonic acid group (—PO₃²⁻) (which can render a substrate surface hydrophilic). In certain embodiments, the non-zwitterionic phosphonic acid-containing compounds used in compositions of the present disclosure include:

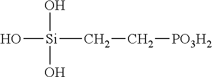

In some embodiments, aqueous compositions used in wipes of the present disclosure include a non-zwitterionic anionic silane compound in an amount of at least 0.0001 weight percent (wt-%), or at least 0.001 wt-%, or at least 0.01 wt-%, or at least 0.05 wt-%, based on the total weight of the composition. In some embodiments, aqueous compositions used in wipes of the present disclosure include a non-zwitterionic anionic silane compound in an amount of up to 10 wt-%, or up to 5 wt-%, or up to 2 wt-%, based on the total weight of the composition.

### Zwitterionic Silanes

Aqueous compositions used in wipes of the present disclosure include one or more zwitterionic silanes. Zwitterionic silanes are neutral compounds that have electrical charges of opposite sign within a molecule, as described in http://goldbook.iupac.org/Z06752.html. Such compounds provide easy-to-clean performance to the aqueous compositions.

Suitable zwitterionic silanes include a zwitterionic sulfonate-functional silane, a zwitterionic carboxylate-functional silane, a zwitterionic phosphate-functional silane, a zwitterionic phosphonic acid-functional silane, a zwitterionic phosphonate-functional silane, or a combination thereof. In certain embodiments, the zwitterionic silane is a zwitterionic sulfonate-functional silane.

In certain embodiments, the zwitterionic silane compounds used in the aqueous compositions used in wipes of the present disclosure have the following Formula (II) wherein:

(R¹O)ₚ—Si(Q¹)_{q}—W—N⁺(R²)(R³)—(CH₂)_{m—Z}^{t-} (II)

wherein:

each R¹ is independently a hydrogen, methyl group, or ethyl group;

each Q¹ is independently selected from hydroxyl, alkyl groups containing from 1 to 4 carbon atoms, and alkoxy groups containing from 1 to 4 carbon atoms;

each R² and R³ is independently a saturated or unsaturated, straight chain, branched, or cyclic organic group (preferably having 20 carbons or less), which may be joined together, optionally with atoms of the group W, to form a ring;

W is an organic linking group;

Z^{t-} is —SO₃⁻, —CO2⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group (preferably having 20 carbons or less, more preferably R is aliphatic having 20 carbons or less, and even more preferably R is methyl, ethyl, propyl, or butyl);

p and m are integers of 1 to 10 (or 1 to 4, or 1 to 3);

q is 0 or 1; and

p+q=3.

In certain embodiments, the organic linking group W of Formula (II) may be selected from saturated or unsaturated, straight chain, branched, or cyclic organic groups. The linking group W is preferably an alkylene group, which may include carbonyl groups, urethane groups, urea groups, heteroatoms such as oxygen, nitrogen, and sulfur, and combinations thereof. Examples of suitable linking groups W include alkylene groups, cycloalkylene groups, alkyl-substituted cycloalkylene groups, hydroxy-substituted alkylene groups, hydroxy-substituted mono-oxa alkylene groups, divalent hydrocarbon groups having mono-oxa backbone substitution, divalent hydrocarbon groups having mono-thia backbone substitution, divalent hydrocarbon groups having monooxo-thia backbone substitution, divalent hydrocarbon groups having dioxo-thia backbone substitution, arylene groups, arylalkylene groups, alkylarylene groups and substituted alkylarylene groups.

Suitable examples of zwitterionic compounds of Formula (II) are described in U.S. Pat. No. 5,936,703 (Miyazaki et al.) and International Publication Nos. WO 2007/146680 and WO 2009/119690, and include the following zwitterionic functional groups (—W—N⁺(R³)(R⁴)—(CH₂)ₘ—SO₃⁻):

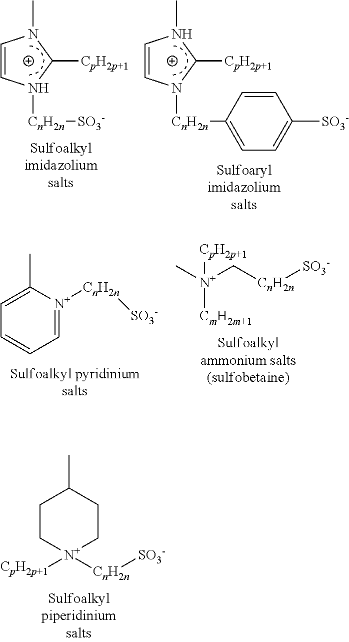

In certain embodiments, the zwitterionic sulfonate-functional silane compounds used in the aqueous compositions used in wipes of the present disclosure have the following Formula (III) wherein:

(R¹O)ₚ—Si(Q¹)_{q}—CH₂CH₂CH₂—N⁺(CH₃)₂—(CH₂)ₘ—SO₃⁻ (III)

wherein:

each R¹ is independently a hydrogen, methyl group, or ethyl group;

each Q¹ is independently selected from hydroxyl, alkyl groups containing from 1 to 4 carbon atoms and alkoxy groups containing from 1 to 4 carbon atoms;

p and m are integers of 1 to 4;

q is 0 or 1; and

p+q=3.

Suitable examples of zwitterionic sulfonate-functional compounds of Formula (III) are described in U.S. Pat. No. 5,936,703 (Miyazaki et al.), including, for example:

(CH₃O)₃Si—CH₂CH₂CH₂—N⁺(CH₃)₂—CH₂CH₂CH₂—SO₃⁻; and

(CH₃CH₂O)₂Si(CH₃)—CH₂CH₂CH₂—N⁺(CH₃)₂—CH₂CH₂CH₂—SO₃⁻.

Other examples of suitable zwitterionic sulfonate-functional compounds, which may be made using standard techniques include the following:

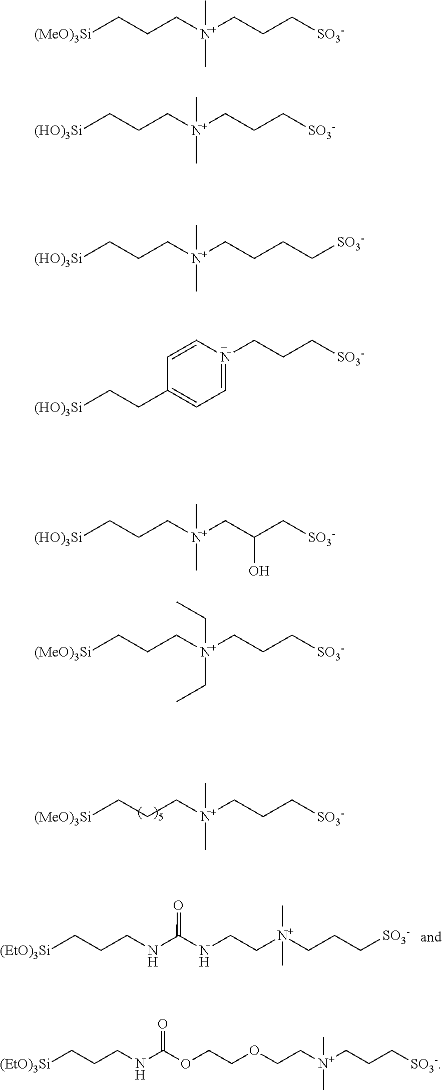

A particularly preferred zwitterionic sulfonate-functional silane is:

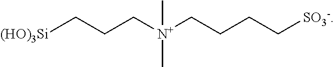

Examples of zwitterionic carboxylate-functional silane compounds include

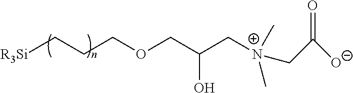

wherein each R is independently OH or alkoxy, and n is 1-10.

Examples of zwitterionic phosphate-functional silane compounds include:

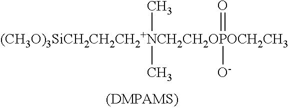

(N,N-dimethyl, N-(2-ethyl phosphate ethyl)-aminopropyl-trimethyoxysilane (DMPAMS)).

Examples of zwitterionic phosphonate-functional silane compounds include:

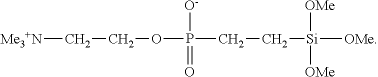

In some embodiments, aqueous compositions used in wipes of the present disclosure include a zwitterionic silane compound in an amount of at least 0.0001 weight percent (wt-%), or at least 0.001 wt-%, or at least 0.01 wt-%, or at least 0.05 wt-%, based on the total weight of the composition. In some embodiments, aqueous compositions used in wipes of the present disclosure include a zwitterionic silane compound in an amount of up to 10 wt-%, or up to 5 wt-%, or up to 2 wt-%, based on the total weight of the composition.

### Surfactants

Aqueous compositions used in wipes of the present disclosure can also include one or more surfactants. Surfactants are particularly desirable for use in cleaning compositions.

A variety of surfactants may be used in an aqueous composition used in a wipe of the present disclosure, such as anionic, nonionic, cationic, and zwitterionic surfactants. Suitable surfactants that may be used are commercially available from a number of sources. For a discussion of suitable surfactants, see Kirk-Othmer, Encyclopedia of Chemical Technology, Third Edition, volume 8, pages 900-912.

Nonionic surfactants include, for example, those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the tradename PLURONIC (BASF-Wyandotte), and the like; and other like nonionic compounds. Silicone surfactants such as those available under the tradename ABIL B8852 can also be used.

Preferred surfactants are any of a broad variety of nonionic ethylene oxide (EO) containing surfactants. Many nonionic ethylene oxide derivative surfactants are water soluble and have cloud points below the intended use temperature of the compositions of the present disclosure. In addition, where the composition is preferred to be biodegradable, the defoamers are also selected to be biodegradable.

Some examples of ethylene oxide derivative surfactants that may be used in aqueous compositions used in wipes of the present disclosure include polyoxyethylene-polyoxypropylene block copolymers, alcohol alkoxylates, low molecular weight EO containing surfactants, or the like, or derivatives thereof. Some examples of polyoxyethylene-polyoxypropylene block copolymers include those having the following formulae:

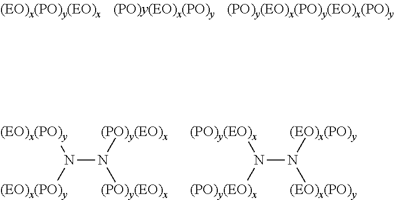

wherein EO represents an ethylene oxide group, PO represents a propylene oxide group, and x and y reflect the average molecular proportion of each alkylene oxide monomer in the overall block copolymer composition. In some embodiments, x is in the range of 10 to 130, y is in the range of 15 to 70, and x plus y is in the range of 25 to 200. It should be understood that each x and y in a molecule may be different. In some embodiments, the total polyoxyethylene component of the block copolymer may be at least 20 mole percent (mol-%) of the block copolymer and in some embodiments, at least 30 mol-% of the block copolymer. In some embodiments, the material may have a molecular weight greater than 400, and in some embodiments, greater than 500. For example, in some embodiments, the material may have a molecular weight in the range of 500 to 7000 or more, or in the range of 950 to 4000 or more, or in the range of 1000 to 3100 or more, or in the range of 2100 to 6700 or more.

Although the exemplary polyoxyethylene-polyoxypropylene block copolymer structures provided above have 3-8 blocks, it should be appreciated that the nonionic block copolymer surfactants can include more or less than 3 or 8 blocks. In addition, the nonionic block copolymer surfactants can include additional repeating units such as butylene oxide repeating units. Furthermore, the nonionic block copolymer surfactants that may be used according to the present disclosure may be characterized hetero-polyoxyethylene-polyoxypropylene block copolymers. Some examples of suitable block copolymer surfactants include commercial products such as those surfactants available under the tradenames PLURONIC and TETRONIC from BASF. For example, PLURONIC 25-R4 is one example of a useful block copolymer surfactant commercially available from BASF, that is biodegradable and GRAS (generally recognized as safe).

Suitable anionic surfactants include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Exemplary anionic surfactants include sodium alkylarylsulfonate, alpha-olefinsulfonate, and fatty alcohol sulfates.

Suitable cationic surfactants include, for example, amines such as primary, secondary and tertiary monoamines with C18 alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl(C₁₂-C₁₈)dimethylbenzyl ammonium chloride, n-tetradecyldimethylbenzylammonium chloride monohydrate, a naphthylene-substituted quaternary ammonium chloride such as dimethyl-1-naphthylmethylammonium chloride, and the like. The cationic surfactant may be used to provide sanitizing properties.

Suitable zwitterionic surfactants include, for example, betaines, imidazolines, and propinates.

In some embodiments, aqueous compositions used in wipes of the present disclosure include a surfactant in an amount of at least 0.001 wt-%, or at least 0.01 wt-%, or at least 0.1 wt-%, or at least 1 wt-%, or at least 2 wt-%, or at least 3 wt-%, based on the total weight of the composition. In some embodiments, aqueous compositions used in wipes of the present disclosure, include a surfactant in an amount of up to 10 wt-%, or up to 5 wt-%, or up to 3 wt-%, or up to lwt-%, based on the total weight of the composition.

### Optional Organic Solvents

Certain embodiments of aqueous compositions used in wipes of the present disclosure may include one or more organic solvents. These may be added to assist in solubilizing components and/or to enhance the cleaning capability of a composition.

Representative solvents and solvent systems may include one or more different solvents including acetone, aliphatic or aromatic alcohols, alkanol amines, ether amines, esters, and mixtures thereof. Representative solvents may include acetone, acetamidophenol, acetanilide, acetophenone, 2-acetyl-1-methylpyrrole, benzyl acetate, benzyl alcohol, methyl benzyl alcohol, alpha phenyl ethanol, benzyl benzoate, benzyloxyethanol, ethylene glycol phenyl ether (commercially available as DOWANOL EPh from Dow Chemical Co.), propylene glycol phenyl ether (commercially available as DOWANOL PPh from Dow Chemical Co.), amyl acetate, amyl alcohol, butanol, 3-butoxyethyl-2-propanol, butyl acetate, n-butyl propionate, cyclohexanone, diacetone alcohol, diethoxyethanol, diethylene glycol methyl ether, diisobutyl carbinol, diisobutyl ketone, dimethyl heptanol, dipropylene glycol tert-butyl ether, ethanol, ethyl acetate, 2-ethylhexanol, ethyl propionate, ethylene glycol methyl ether acetate, hexanol, isobutanol, isobutyl acetate, isobutyl heptyl ketone, isophorone, isopropanol, isopropyl acetate, methanol, methyl amyl alcohol, methyl n-amyl ketone, 2-methyl-I-butanol, methyl ethyl ketone, methyl isobutyl ketone, 1-pentanol, n-pentyl propionate, 1-propanol, n-propyl acetate, n-propyl propionate, propylene glycol ethyl ether, tripropylene glycol methyl ether (commercially available as DOWANOL TPM from Dow Chemical Co.), tripropylene glycol n-butyl ether (commercially available as DOWANOL TPNB from Dow Chemical Co.), diethylene glycol n-butyl ether acetate (commercially available as Butyl CARBITOL acetate from Dow Chemical Co.), diethylene glycol monobutyl ether (commercially available as Butyl CARBITOL from Dow Chemical Co.), ethylene glycol n-butyl ether acetate (commercially available as Butyl CELLOSOLVE acetate from Dow Chemical Co.), ethylene glycol monobutyl ether (commercially available as Butyl CELLOSOLVE from Dow Chemical Co.), dipropylene glycol monobutyl ether (commercially available as Butyl DIPROPASOL™ from Dow Chemical Co.), propylene glycol monobutyl ether (commercially available as Butyl PROPASOL from Dow Chemical Co.), ethyl 3-ethoxypropionate (commercially available as UCAR Ester EEP from Dow Chemical Co.), 2,2,4-Trimethyl-1,3-Pentanediol Monoisobutyrate (commercially available as UCAR Filmer IBT from Dow Chemical Co.), diethylene glycol monohexyl ether (commercially available as Hexyl CARBITOL from Dow Chemical Co.), ethylene glycol monohexyl ether (commercially available as Hexyl CELLOSOLVE from Dow Chemical Co.), diethylene glycol monomethyl ether (commercially available as Methyl CARBITOL from Dow Chemical Co.), diethylene glycol monoethyl ether (commercially available as CARBITOL from Dow Chemical Co.), ethylene glycol methyl ether acetate (commercially available as Methyl CELLOSOLVE acetate from Dow Chemical Co.), ethylene glycol monomethyl ether (commercially available as Methyl CELLOSOLVE from Dow Chemical Co.), dipropylene glycol monomethyl ether (commercially available as Methyl DIPROPASOL from Dow Chemical Co.), propylene glycol methyl ether acetate (commercially available as Methyl PROPASOL acetate from Dow Chemical Co.), propylene glycol monomethyl ether (commercially available as Methyl PROPASOL from Dow Chemical Co.), diethylene glycol monopropyl ether (commercially available as Propyl CARBITOL from Dow Chemical Co.), ethylene glycol monopropyl ether (commercially available as Propyl CELLOSOLVE from Dow Chemical Co.), dipropylene glycol monopropyl ether (commercially available as Propyl DIPROPASOL from Dow Chemical Co.) and propylene glycol monopropyl ether (commercially available as Propyl PROPASOL from Dow Chemical Co.). Representative dialkyl carbonates include dimethyl carbonate, diethyl carbonate, dipropyl carbonate, diisopropyl carbonate and dibutyl carbonate. Representative oils include benzaldehyde, pinenes (alphas, betas, etc.), terpineols, terpinenes, carvone, cinnamealdehyde, borneol and its esters, citrals, ionenes, jasmine oil, limonene, dipentene, linalool and its esters. Representative dibasic esters include dimethyl adipate, dimethyl succinate, dimethyl glutarate, dimethyl malonate, diethyl adipate, diethyl succinate, diethyl glutarate, dibutyl succinate, dibutyl glutarate and products available under the trade designations DBE, DBE-3, DBE-4, DBE-5, DBE-6, DBE-9, DBE-IB, and DBE-ME from DuPont Nylon. Representative phthalate esters include dibutyl phthalate, diethylhexyl phthalate and diethyl phthalate.

In some embodiments, aqueous compositions used in wipes of the present disclosure include alcohol and/or other organic solvents in an amount of at least 0.01 weight percent (wt-%), and often at least 2 wt-%, based on the total weight of the composition. In some embodiments, aqueous compositions used in wipes of the present disclosure include alcohol and/or other organic solvents in an amount of up to 50 wt-%, and often up to 25 wt-%, based on the total weight of the composition.

### Optional Alkalinity Sources

Certain embodiments of aqueous compositions used in wipes of the present disclosure may include one or more alkalinity (i.e., alkaline) sources.

Examples of suitable alkaline sources for use in the aqueous compositions used in wipes according to the present disclosure include amines, alkanol amines, carbonates, and silicates. For example, the source of alkalinity can include sodium silicate, sodium metasilicate, sodium orthosilicate, sodium phosphate, sodium polyphosphate, sodium borate, sodium carbonate, potassium silicate, potassium metasilicate, potassium orthosilicate, potassium phosphate, potassium polyphosphate, potassium borate, potassium carbonate, lithium silicate, lithium metasilicate, lithium orthosilicate, lithium phosphate, lithium polyphosphate, lithium borate, lithium carbonate, 2-(2-aminoethoxy) ethanol, monoethanolamine, diethanolamine, triethanolamine, mixed isopropanolamines, morpholine, n,n-dimethyl ethanolamine, and combinations thereof.

When an aqueous composition used in wipes of the present disclosure includes an alkalinity source, it may be included in an amount of at least 0.01 wt-%, or at least 1 wt-%, or at least 5 wt-%, based on the total weight of the composition (not including the fibrous substrate). When a composition of the present disclosure includes an alkalinity source, it may be included in an amount of up to 40 wt-%, or up to 30 wt-%, or up to 10 wt-%, based on the total weight of the composition (not including the fibrous substrate).

### Optional Water Conditioning Agents

Certain embodiments of aqueous compositions used in wipes of the present disclosure may include one or more water conditioning agents. Water conditioning agents aid in removing metal compounds and in reducing harmful effects of hardness components in service water. Exemplary water conditioning agents include chelating agents, sequestering agents, and inhibitors. Polyvalent metal cations or compounds such as a calcium, a magnesium, an iron, a manganese, a molybdenum, etc., cation or compound, or mixtures thereof, can be present in service water and in complex soils. Such compounds or cations can interfere with the effectiveness of a washing or rinsing compositions during a cleaning application. A water conditioning agent can effectively complex and remove such compounds or cations from soiled surfaces and can reduce or eliminate the inappropriate interaction with active ingredients including the nonionic surfactants and anionic surfactants of the present disclosure. Both organic and inorganic water conditioning agents are common and can be used. Inorganic water conditioning agents include such compounds as sodium tripolyphosphate and other higher linear and cyclic polyphosphates species. Organic water conditioning agents include both polymeric and small molecule water conditioning agents. Organic small molecule water conditioning agents are typically organocarboxylate compounds or organophosphate water conditioning agents. Polymeric inhibitors commonly comprise polyanionic compositions such as polyacrylic acid compounds. Small molecule organic water conditioning agents include, but are not limited to, sodium gluconate, sodium glucoheptonate, N-hydroxyethylenediaminetriacetic acid (HEDTA), ethylenediaminetetraacetic acid (EDTA), nitrilotriacetic acid (NTA), diethylenetriaminepentaacetic acid (DTPA), ethylenediaminetetraproprionic acid, triethylenetetraaminehexaacetic acid (TTHA), and the respective alkali metal, ammonium, and substituted ammonium salts thereof, ethylenediaminetetraacetic acid tetrasodium salt (EDTA), nitrilotriacetic acid trisodium salt (NTA), ethanoldiglycine disodium salt (EDG), diethanolglycine sodium-salt (DEG), and 1,3-propylenediaminetetraacetic acid (PDTA), dicarboxymethyl glutamic acid tetrasodium salt (GLDA), methylglycine-N N-diacetic acid trisodium salt (MGDA), and iminodisuccinate sodium salt (IDS). Suitable water conditioning agents are commercially available.

When an aqueous composition used in wipes of the present disclosure includes a water conditioning agent, it may be included in an amount of at least 0.01 wt-%, or at least 0.1 wt-%, or at least 1 wt-%, based on the total weight of the composition (not including the fibrous substrate). When a composition of the present disclosure includes a water conditioning agent, it may be included in an amount of up to 40 wt-%, or up to 20 wt-%, or up to 10 wt-%, or up to 5 wt-%, based on the total weight of the composition (not including the fibrous substrate).

### Optional Bleaching Agents

Certain embodiments of aqueous compositions used in wipes of the present disclosure may include one or more bleaching agents. Bleaching agents may be included for lightening or whitening a substrate.

Examples of suitable bleaching agents include bleaching compounds capable of liberating an active halogen species (such as Cl₂, Br₂, OCl⁻, and/or OBr⁻) under conditions typically encountered during the cleansing process. Suitable bleaching agents for use in the present compositions include, for example, chlorine-containing compounds such as a chlorine, a hypochlorite, and chloramine. Exemplary halogen-releasing compounds include the alkali metal dichloroisocyanurates, chlorinated trisodium phosphate, the alkali metal hypochlorites, monochloramine and dichloramine, and the like. Encapsulated chlorine sources may also be used to enhance the stability of the chlorine source in the composition (see, for example, U.S. Pat. No. 4,830,773 (Olson)). A bleaching agent may also be a peroxygen or active oxygen source such as hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like.

When an aqueous composition used in wipes of the present disclosure includes a bleaching agent, it may be included in an amount of at least 0.1 wt-%, or at least 1 wt-%, or at least 3 wt-%, based on the total weight of the composition (not including the fibrous substrate). When a composition of the present disclosure includes a bleaching agent, it may be included in an amount of up to 60 wt-%, or up to 20 wt-%, or up to 8 wt-%, or up to 6 wt-%, based on the total weight of the composition (not including the fibrous substrate).

### Other Optional Additives

Certain embodiments of aqueous compositions used in wipes of the present disclosure may include one or more other additives. Suitable additives may include, for example, dyes (product safety/identification), fragrances, corrosion inhibitors, enzymes, and/or thickeners. Suitable thickeners may include, for example, gums (e.g., xanthan, carrageenan, etc.), polymers (e.g., polyacrylates and similar modified polymers), inorganic particles (e.g., clay silicates such as LAPONITE).

Various additional additives suitable for use according to the present disclosure are disclosed in U.S. Pat. No. 6,916,773 (Griese et al.) and U.S. Pat. No. 8,772,215 (Ryther et al.), and U.S. Pat. App. Pub. Nos. 2010/0317559 (Ryther et al.), 2012/0295829 (Peitersen et al.), and 2013/0023458 (Hodge et al.).

### Illustrative Embodiments

Embodiment 1 is a wipe (e.g., a cleaning and protecting wipe) comprising a fibrous substrate and an aqueous composition impregnated therein, wherein: the fibrous substrate comprises oleophilic fibers and hydrophilic fibers in amounts within a weight ratio range of 10:90 to 90:10; and the aqueous composition comprises: greater than 0 wt-% and up to 50 wt-% of a silicate; a non-zwitterionic anionic silane; a zwitterionic silane; and water; wherein the weight percent of silicate is based on the total weight of silane(s) plus silicate(s) solids in the composition.

Embodiment 2 is the wipe of embodiment 1 wherein the zwitterionic silane comprises a zwitterionic sulfonate-functional silane, a zwitterionic carboxylate-functional silane, a zwitterionic phosphate-functional silane, a zwitterionic phosphonic acid-functional silane, a zwitterionic phosphonate-functional silane, or a combination thereof.

Embodiment 3 is the wipe of embodiment 2 wherein the zwitterionic silane has the following formula (Formula II):

(R¹O)ₚ—Si(Q¹)_{q}—W—N⁺(R²)(R³)—(CH₂)ₘ—Z^{t-} (II)

wherein:
each R¹ is independently a hydrogen, methyl group, or ethyl group;
each Q¹ is independently selected from hydroxyl, alkyl groups containing from 1 to 4 carbon atoms, and alkoxy groups containing from 1 to 4 carbon atoms;
each R² and R³ is independently a saturated or unsaturated, straight chain, branched, or cyclic organic group, which may be joined together, optionally with atoms of the group W, to form a ring;
W is an organic linking group;
Z^{t-} is —SO₃⁻, —CO₂⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group, or a combination thereof.
p and m are integers of 1 to 10;
q is 0 or 1; and
p+q=3.

Embodiment 4 is the wipe of any one of embodiments 1 to 3 wherein the zwitterionic silane is present in an amount of 0.0001 wt-% to 10 wt-%, based on the total weight of the aqueous composition.

Embodiment 5 is the wipe of any one of embodiments 1 to 4 wherein the silicate is an inorganic silicate.

Embodiment 6 is the wipe of embodiment 5 wherein the silicate is selected from lithium silicate, sodium silicate, potassium silicate, or a combination thereof.

Embodiment 7 is the wipe of any one of embodiments 1 to 6 wherein the non-zwitterionic anionic silane comprises one or more associative functional groups.

Embodiment 8 is the wipe of embodiment 7 wherein the non-zwitterionic anionic silane comprises a non-zwitterionic sulfonate-functional silane, a non-zwitterionic carboxylate-functional silane, a non-zwitterionic phosphate-functional silane, a non-zwitterionic phosphonic acid-functional silane, a non-zwitterionic phosphonate-functional silane, or a combination thereof.

Embodiment 9 is the wipe of embodiment 8 wherein the non-zwitterionic anionic silane has the following formula (Formula I):

[(MO)(Q²)ₙSi(XCH₂V^{t-})₃₋ₙ]Y_{2/nr}_{^{+r}} (I)

wherein:
each Q² is independently selected from hydroxyl, alkyl groups containing from 1 to 4 carbon atoms, and alkoxy groups containing from 1 to 4 carbon atoms;
M is selected from hydrogen, alkali metals, and organic cations of strong organic bases having an average molecular weight of less than 150 and a pKa of greater than 11;
X is an organic linking group;
V^{t-} is —SO₃⁻, —CO₂⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group, or a combination thereof.
Y is selected from hydrogen, alkaline earth metals, organic cations of protonated weak bases having an average molecular weight of less than 200 and a pKa of less than 11, alkali metals, and organic cations of strong organic bases having an average molecular weight of less than 150 and a pKa of greater than 11, provided that M is hydrogen when Y is selected from hydrogen, alkaline earth metals and organic cations of said protonated weak bases;
r is equal to the valence of Y; and
n is 1 or 2.

Embodiment 10 is the wipe of any of embodiments 1 to 9 wherein the non-zwitterionic anionic silane is present in an amount of 0.0001 wt-% to 10 wt-%, based on the total weight of the aqueous composition.

Embodiment 11 is the wipe of any of embodiments 1 to 10 wherein the aqueous composition further comprises a surfactant.

Embodiment 12 is the wipe of embodiment 11 wherein the surfactant comprises an anionic, nonionic, cationic, or zwitterionic surfactant.

Embodiment 13 is the wipe of embodiment 11 or 12 wherein the surfactant is present in an amount of 0.001 wt-% to 10 wt-%, based on the total weight of the aqueous composition.

Embodiment 14 is the wipe of any of embodiments 1 to 13 wherein the substrate has a mass of at least 20 g/m² (or at least 30 g/m², at least 40 g/m², at least 50 g/m², at least 60 g/m², at least 70 g/m², or at least 80 g/m²).

Embodiment 15 is the wipe of any of embodiments 1 to 14 wherein the substrate has a mass of up to 140 g/m² (or up to 120 g/m²).

Embodiment 16 is the wipe of any of embodiments 1 to 15 wherein the hydrophilic fibers comprise cellulose fibers, rayon fibers (viscose, modal, and lyocell fibers), cotton fibers, polyamide fibers, polyacrylic acid fibers, fibers treated with surfactant, or combinations thereof.

Embodiment 17 is the wipe of any of embodiments 1 to 16 wherein the oleophilic fibers comprise polyurethane fibers, polypropylene fibers, polyethylene fibers, polyethylene terephthalate fibers, or combinations thereof.

Embodiment 18 is the wipe of any of embodiments 1 to 17 wherein the oleophilic fibers and hydrophilic fibers are present in amounts within a weight ratio range of 20:80 to 80:20.

Embodiment 19 is the wipe of embodiment 18 wherein the oleophilic fibers and hydrophilic fibers are present in amounts within a weight ratio range of 30:70 to 70:30.

Embodiment 20 is the wipe of embodiment 19 wherein the oleophilic fibers and hydrophilic fibers are present in amounts within a weight ratio range of 40:60 to 60:40.

Embodiment 21 is the wipe of embodiment 20 wherein the oleophilic fibers and hydrophilic fibers are present in amounts of 50:50.

Embodiment 22 is the wipe of any of embodiments 1 to 21 wherein the aqueous composition is present in an amount of at least 2 grams composition per gram wipe (or at least 3 grams per gram wipe, or at least 3.5 grams per gram wipe).

Embodiment 23 is the wipe of any of embodiments 1 to 22 wherein the aqueous composition is present in an amount of up to 6 grams composition per gram wipe (or up to 5.5 grams per gram wipe).

Embodiment 24 is the wipe of any of embodiments 1 to 23 which demonstrates fingerprint removal of at least 75% (at least 90% or at least 100%) after 5 testing cycles according to the Fingerprint Removal Test With Wipe Media Application.

Embodiment 25 is the wipe of any of embodiments 1 to 24 which demonstrates oil removal of at least 75% (at least 90% or at least 100%) after 5 testing cycles according to the Vegetable Oil Removal Test With Wipe Media Application.

Embodiment 26 is the wipe of any of embodiments 1 to 25 comprising a fibrous substrate which demonstrates a water absorption ratio of at least 9 grams (or at least 10 grams, or at least 10.5 grams) water to 1 gram substrate according to the Absorption Test.

Embodiment 27 is the wipe of any of embodiments 1 to 26 comprising a fibrous substrate which demonstrates total water absorbed in an amount of at least 300 grams (or at least 400 grams) per square meter of fibrous substrate according to the Absorption Test.

Embodiment 28 is the wipe of any of embodiments 1 to 27 comprising a fibrous substrate which demonstrates an oil absorption ratio of at least 9 grams (or at least 10 grams, or at least 10.5 grams) oil to 1 gram substrate according to the Absorption Test.

Embodiment 29 is the wipe of any of embodiments 1 to 28 comprising a fibrous substrate which demonstrates total oil absorbed in an amount of at least 200 grams (or at least 300 grams) per square meter of fibrous substrate according to the Absorption Test.

Embodiment 30 is a method of coating a surface, the method comprising: providing a wipe of any of the previous embodiments; applying the aqueous composition to the surface; and allowing the aqueous composition to dry on the surface.

Embodiment 31 is the method of embodiment 30 which is a method of cleaning and protecting a surface and applying the aqueous composition comprises applying the aqueous composition to the surface under conditions effective to remove contaminants from the surface.

Embodiment 32 is the method of embodiment 31 wherein the contaminants comprise an oily residue.

Embodiment 33 is the method of any of embodiments 30 to 32 wherein the surface is a metallic surface.

Embodiment 34 is the method of embodiment 33 wherein the metallic surface comprises stainless steel, aluminum, anodized aluminum, titanium, zinc, silver, a surface oxide thereof, or a combination thereof.

Embodiment 35 is the method of embodiment 34 wherein the metallic surface comprises stainless steel, aluminum, anodized aluminum, a surface oxide thereof, or a combination thereof.

Embodiment 36 is the method of any of embodiments 30 to 35 wherein the surface forms at least a portion of an article.

Embodiment 37 is the method of embodiment 36 wherein the article is in a commercial kitchen.

Embodiment 38 is the method of embodiment 36 or 37 wherein the article is a refrigerator, dishwasher, stove, oven, microwave, exhaust hood, fryer, grease trap, food-preparation table, cabinet, toilet stall partition, urinal partition, decorative or functional wall cladding in or on an elevator or escalator, wall in a commercial building, decorative or functional panel in an automobile, metal case for an electronic article, piece of manufacturing equipment, or tool.

### EXAMPLES

Objects and advantages of various embodiments of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

Cleaning and protecting compositions for stainless steel and other metal surfaces are described in U.S. Pat. Pub. No. 2017/0275495 (Riddle et al.). Their use in combination with a wiping media to simultaneously remove grease, oil, and other soil contaminants is described below. The benefit of the combination of the protector chemistry combined with cleaning agents and a suitable wiping media is demonstrated in the results.

### Materials

| Abbreviation | Description |
|---|---|
| A1 | Additive 1 -- TOMADOL 91-6 available from Air Products and |
| | Chemicals Inc, Allentown, PA. |
| A2 | Additive 2 -- TERGITOL 15-S-3 available from Dow Chemical of |
| | Woodland, MI. |
| A3 | Additive 3 -- Monoethanol amine available from Ineos Oxide of |
| | Houston, TX. |
| A4 | Additive 4 -- NaOH available from EMD Millipore of Billerica, MA. |
| A5 | Additive 5 -- Biosoft S-101 available from Stepan, Northfield, IL |
| S1 | Solvent 1 -- Benzyl alcohol available from Nexeo Solution of The |
| | Woodlands, TX. |
| SUB1 | Substrate 1 -- SS grade Multipurpose 304 (0.024-inch thick) with a |
| | brush finish (#3) available from McMaster-Carr of Elmhurst, IL. |
| SO1 | Soil 1 -- Vegetable Oil under trade name of Wesson available from |
| | ConAgra Foods Omaha, NE. |
| SO2 | PLANTERS 100% Peanut oil (Kraft Heinz Company, Chicago, IL). |
| P1 | Protector 1 -- Zwiterionic silane prepared from 3-(N,N- |
| | dimethylaminopropyl)trimethoxysilane available from Gelest Inc, |
| | Morrisville, PA (49.7 g, 239 mmol) and added to a screw-top jar |
| | followed by deionized (DI) water (82.2 g) and 1,4-butane sultone |
| | available from ORGANICA Feinchemie GmbH Wolfen Ortsteil |
| | Wolfen Kunstseidestrasse 5 (32.6 g, 239 mmol). The reaction |
| | mixture was heated to 75° C. and mixed for 14 hours affixed to a reflux |
| | condenser. |
| P2 | Protector 2 -- Phos silane is 3-(Trihydroxysilyl)propyl |
| | methylphosphonate, monosodium salt solution 42% in water |
| | available from Sigma-Aldrich, St. Louis, MO. |
| P3 | Protector 3 -- LSS-75 lithium silicate (50:50 w/w)] available from |
| | Nissan Chemical America Corporation, Houston, TX. |
| W1 | Fibrous Substrate 1 -- Spuntech 80 gsm SQ VIS 30% PET 70% wipe |
| | available from Spuntech Industries, Inc., Roxboro, NC. |
| W2 | Fibrous Substrate 2 -- 100% woodpulp (100% hydrophilic fibers) |
| | available from Kimberly-Clark Corp., Irving, TX as KIMWIPES. |
| W3 | Fibrous Substrate 3 -- Jacob Holm 41 gsm PET 100% (100% |
| | oleophilic fibers) available from Jacob Holm Industries, Basel, |
| | Switzerland as 11.041.003 |
| W4 | Fibrous Substrate 4 -- Jacob Holm 68 gsm PET 100% available from |
| | Jacob Holm Industries, Basel, Switzerland as 11.068.001 |
| W5 | Fibrous Substrate 5 -- Jacob Holm 45 gsm VIS 30% PET 70% |
| | available from Jacob Holm Industries, Basel, Switzerland as |
| | 20.045.056 |
| W6 | Fibrous Substrate 6 -- Jacob Holm 68 gsm VIS 30% PET 70% |
| | available from Jacob Holm Industries, Basel, Switzerland as |
| | 20.068.003 |
| W7 | Fibrous Substrate 7 -- Jacob Holm 45 gsm VIS 50% PET 50% |
| | available from Jacob Holm Industries, Basel, Switzerland as |
| | 20.045.075 |
| W8 | Fibrous Substrate 8 -- Jacob Holm 57 gsm VIS 50% PET 50% |
| | available from Jacob Holm Industries, Basel, Switzerland as |
| | 20.057.007 |
| W9 | Fibrous Substrate 9 -- Jacob Holm 100 gsm VIS 50% PET 50% |
| | available from Jacob Holm Industries, Basel, Switzerland as |
| | 20.100.004 |
| W10 | Fibrous Substrate 10 -- Jacob Holm 50 gsm VIS 70% PET 30% |
| | available from Jacob Holm Industries, Basel, Switzerland as |
| | 20.050.067 |
| W11 | Fibrous Substrate 11 -- Jacob Holm 60 gsm VIS 70% PET 30% |
| | available from Jacob Holm Industries, Basel, Switzerland as |
| | 20.060.051 |

### Test Methods

Fingerprint Removal Test with Wipe Media Application

The samples from Table 1 were tested for their cleanability (of fingerprints), the longevity of the coatings when subjected to repeated soiling tests and the removal of fingerprints while subsequently imparting protective chemistry on a surface.

Stainless steel test panels (SUB1) were precleaned using Alconox detergent powder, available from Alconox Inc. Panels were scrubbed vigorously by hand with the powder mixed with deionized water and a Wypall X30 available from Kimberly-Clark Co. to remove oxidative surface layer. Panels were then rinsed with deionized water to remove any Alconox residue and dried thoroughly before testing. Panels should not be left more than 24 hours after this preclean cycle to avoid oxidative surface layer generation.

Using facial oil, the stainless steel panels had a fingerprint applied on each sample with approximately (˜) 250 grams (g) of force, the samples were allowed to stand for a period of time less than 5 minutes at room temperature. The Operator lightly touched a clean finger to the side of their nose, or alternately their forehead to produce a fingerprint with sufficient facial oil to be easily seen with the naked eye on the panel. Each preparative solution was then applied via a wipe which was first submerged in the preparative solution. Ten (10) strokes, or 5 cycles back and forth across the fingerprint on the panels were performed. Application cycles of the solution were performed with the same force of ˜250 g as the fingerprint oil was deposited onto the panels. The panels were allowed to dry at least 5 minutes between cleanings and the process repeated 5 times. After the 5^{th} fingerprint removal cycle the panels were allowed to dry for 12 hours before proceeding. For the removal test, a fingerprint was applied to the coated surfaces of samples from Example table 1 using facial oil and approximately (˜) 250 grams (g) of force. The samples were allowed to stand for a period of time less than 5 minutes at room temperature. The samples were subsequently subjected to Comparative Example 1 (1 mL) applied via pipette over a period of 30 seconds before drying the samples with compressed air. The samples were visually inspected and scored on a scale of 1=good to 5=bad. If the fingerprint was not removed (samples scored >3) no further testing was done for that sample. If the fingerprint was removed successfully, samples were resubjected to the test until the samples failed. The results are listed in Table 1.

For testing, the following scale represents description of cleaning ratings:
5=Essentially no removal of fingerprint;
4=Approximately 25% of fingerprint removed with respect to surface area;
3=Approximately 50% of fingerprint removed with respect to surface area;
2=Approximately 75% of fingerprint removed with respect to surface area; and
1=Approximately all fingerprint was removed, only trace amounts may remain.
   Vegetable Oil Removal Test with Wipe Media Application

The samples from Table 1 were tested for their cleanability (of vegetable oil), the longevity of the coatings when subjected to repeated soiling tests and the removal of oil while subsequently imparting protective chemistry on a surface.

Stainless steel test panels (SUB1) were precleaned using Alconox detergent powder, available from Alconox Inc. Panels were scrubbed vigorously by hand with the powder mixed with deionized water and a Wypall X30 available from Kimberly-Clark Co. to remove oxidative surface layer. Panels were then rinsed with deionized water to remove any Alconox residue and dried thoroughly before testing. Panels should not be left more than 24 hours after this preclean cycle to avoid oxidative surface layer generation.

The stainless steel panels (10.2×12.7 cm) had a drop of SO1 applied to the center, droplets approximately 0.15 g in mass. Each preparative solution was then applied via a wipe which was first submerged in the preparative solution. Ten (10) strokes, or 5 cycles back and forth across the oil drop on the panels were performed. Application cycles of the solution were performed with the same force of ˜250 g. The panels were allowed to dry at least 5 minutes between cleanings and the process repeated 5 times. After the 5^{th} oil removal cycle the panels were allowed to dry for 12 hours before proceeding. For the longevity test, a drop of vegetable oil was applied to the coated surfaces of samples from Table 1 and the samples were allowed to stand for a period of time less than 5 minutes at room temperature. The samples were subsequently subjected to Comparative Example 1 (1 mL) applied via pipette over a period of 30 seconds before drying the samples with compressed air. The samples were visually inspected and scored on a scale of 1=good to 5=bad. If the oil was not removed (samples scored >3) no further testing was done for that sample. If the oil was removed successfully, samples were resubjected to the test until the samples failed.

For testing, the following scale represents description of cleaning ratings:
5=Essentially no removal of oil;
4=Approximately 25% of oil removed with respect to surface area;
3=Approximately 50% of oil removed with respect to surface area;
2=Approximately 75% of oil removed with respect to surface area; and
1=Approximately all oil was removed, only trace amounts may remain.

### Absorption Test

The fibrous substrate samples from Table 2 were tested for their absorption capabilities of both water (deionized) and SO2 (peanut oil). Samples were cut into roughly 4 inch×5 inch (10.2 cm×12.7 cm) inch shapes and weighed for its pre-soak weight (PRE). A basin was filled with the liquid to be absorbed and the sample was submerged. After five minutes, the sample was hung vertically on a clip suspended above the basin. After thirty seconds of hanging, the sample was placed in a tared secondary container and weighed for its post-soak weight (POST). PRE was subtracted from POST to find the total liquid absorbed (LIQUID). LIQUID was divided by PRE to give a ratio of the amount of liquid absorbed per gram of fibrous substrate sample. Liquid amount per square meter was calculated by multiplying the measured absorption ratio by the basis weight (in g/m²) of the substrate.

### EXAMPLE PREPARATION

The following examples were prepared and tested as described per the methods.
Preparative Example 1 (PE1) coating solution contained 2 wt-% of [zwit silane:LSS-75 lithium silicate:phos silane (35:30:35 w/w)], 12.8 wt-% of [monoethanol amine:benzyl alcohol:BIOSOFT 101 (36.7:37.5:25.8 w/w)] and 0.4 wt-% of TERGITOL 15-S-3 in deionized water. Applied via a saturated fibrous substrate W1.

Preparative Example 2 (PE2) coating solution contained 2 wt-% of [zwit silane:LSS-75 lithium silicate:phos silane (35:30:35 w/w)], 2 wt-% of NaOH, and 0.1 wt-% of TOMADOL 91-6 in deionized water. Applied via a saturated fibrous substrate W1.

Preparative Example 3 (PE3) coating solution contained 2 wt-% of [zwit silane:LSS-75 lithium silicate:phos silane (35:30:35 w/w)], 12.8 wt-% of [monoethanol amine:benzyl alcohol:BIOSFOFT 101 (36.7:37.5:25.8 w/w)] and 0.4 wt-% of TERGITOL 15-S-3 in deionized water. Applied via a saturated fibrous substrate W2.

Preparative Example 4 (PE4) coating solution contained 2 wt-% of [zwit silane:LSS-75 lithium silicate:phos silane (35:30:35 w/w)], 2 wt-% of NaOH, and 0.1 wt-% of TOMADOL 91-6 in deionized water. Applied via a saturated fibrous substrate W2.

Comparative Example 1 (CE1) cleaning solution was prepared as a 0.1 wt-% of TOMADOL 91-6 in deionized water.

Comparative Example 2 (CE2) coating solution contained 2 wt-% of NaOH, and 0.1 wt-% of TOMADOL 91-6 in water. Applied via a saturated fibrous substrate W1.

Comparative Example 3 (CE3) coating solution contained 12.8 wt-% of [monoethanol amine:benzyl alcohol:BIOSOFT 101 (36.7:37.5:25.8 w/w)] and 0.4 wt-% of TERGITOL 15-S-3 in deionized water. Applied via a saturated fibrous substrate W1.

Comparative Example 4 (CE4) coating solution contained 2 wt-% of NaOH, and 0.1 wt-% of TOMADOL 91-6 in water. Applied via a saturated fibrous substrate W2.

Comparative Example 5 (CE5) coating solution contained 12.8 wt-% of [monoethanol amine:benzyl alcohol:BIOSOFT 101 (36.7:37.5:25.8 w/w)] and 0.4 wt-% of TERGITOL 15-S-3 in deionized water. Applied via a saturated fibrous substrate W2.

TABLE 1
Results Cleaning and Protecting

| Example | | Solution | | | # Oil | #Fingerprint |
|---|---|---|---|---|---|---|
| Number | Solution | Details | Wipe | Substrate | Cycles | Cycles |
| 1 | PE1 | 2 wt % | W1 | SUB1 | >5 | >5 |
| | | 35:30:35 | | | | |
| | | zwit/LiSi/Phos + | | | | |
| | | surfactant + | | | | |
| | | monoethanol | | | | |
| | | amine + benzyl | | | | |
| | | alcohol + | | | | |
| | | sulfonic acid | | | | |
| 2 | PE2 | 2 wt % | W1 | SUB1 | 3 | 3 |
| | | 35:30:35 | | | | |
| | | zwit/LiSi/Phos + | | | | |
| | | surfactant + | | | | |
| | | 2% NaOH | | | | |
| 3 | PE3 | 2 wt % | W2 | SUB1 | <1 | 3 |
| (Comparison) | | 35:30:35 | | | | |
| | | zwit/LiSi/Phos + | | | | |
| | | surfactant + | | | | |
| | | monoethanol | | | | |
| | | amine + benzyl | | | | |
| | | alcohol + | | | | |
| | | sulfonic acid | | | | |
| 4 | PE4 | 2 wt % | W2 | SUB1 | <1 | 2 |
| (Comparison) | | 35:30:35 | | | | |
| | | zwit/LiSi/Phos + | | | | |
| | | surfactant + | | | | |
| | | 2% NaOH | | | | |
| 5 | CE2 | surfactant + 2% | W1 | SUB1 | <1 | 1 |
| (Comparison) | | NaOH | | | | |
| 6 | CE3 | surfactant + | W1 | SUB1 | <1 | <1 |
| (Comparison) | | monoethanol | | | | |
| | | amine + benzyl | | | | |
| | | alcohol + | | | | |
| | | sulfonic acid | | | | |
| 7 | CE4 | surfactant + 2% | W2 | SUB1 | <1 | <1 |
| (Comparison) | | NaOH | | | | |
| 8 | CE5 | surfactant + | W2 | SUB1 | <1 | <1 |
| (Comparison) | | monoethanol | | | | |
| | | amine + benzyl | | | | |
| | | alcohol + | | | | |
| | | sulfonic acid | | | | |

TABLE 2
Nonwoven Absorption Testing

| | | Basis | Water | Oil | Water | Oil |
|---|---|---|---|---|---|---|
| | | Weight | Absorption | Absorption | Absorbed | Absorbed |
| Name | Blend | (g/m²) | Ratio (g/g) | Ratio (g/g) | per m² (g) | per m² (g) |
| W2 | 100% Wood | 21.5 | 5.1 | 6.6 | 111.4 | 144.3 |
| | Pulp | | | | | |
| | (Comparison) | | | | | |
| W3 | 100% PET | 41 | 9.33 | 15.58 | 382.5 | 638.8 |
| | (Comparison) | | | | | |
| W4 | 100% PET | 68 | 9.95 | 14.43 | 676.6 | 981.2 |
| | (Comparison) | | | | | |
| W5 | 70% PET | 45 | 10.71 | 16.45 | 482.0 | 740.3 |
| | 30% Viscose | | | | | |
| W6 | 70% PET | 68 | 10.01 | 14.60 | 680.7 | 992.8 |
| | 30% Viscose | | | | | |
| W7 | 50% PET | 45 | 11.48 | 16.97 | 516.6 | 763.7 |
| | 50% Viscose | | | | | |
| W8 | 50% PET | 57 | 9.96 | 12.73 | 567.7 | 725.6 |
| | 50% Viscose | | | | | |
| W9 | 50% PET | 100 | 9.16 | 10.90 | 916.0 | 1090.0 |
| | 50% Viscose | | | | | |
| W10 | 30% PET | 50 | 11.42 | 11.36 | 571 | 568 |
| | 70% Viscose | | | | | |
| W11 | 30% PET | 60 | 10.85 | 10.20 | 651 | 612 |
| | 70% Viscose | | | | | |

Pure wood pulp fibers (100% hydrophilic fibers) do not have sufficient water absorption for effective holding capacity of the aqueous composition described herein, nor do they have sufficient oil absorption for effective contaminant removal.

Even though pure PET fibers (i.e., 100% PET fibers) showed desirable water absorption/absorbed and oil absorption/absorbed values, such fibrous substrates are undesirable in actual use for several reasons. The nonconformity of the 100% PET fibers adversely affect the overall feel of the wipe for the user, as well as the feel of the wipe contacting the surface to be cleaned. The overall stiffness of a 100% PET fibrous substrate can create less contact with the surface to be cleaned, resulting in a less efficient exchange of the cleaning solution with soil to be removed. This negatively impacts the experience of the user by decreasing the total area they can address in one pass, resulting in increased time and labor to compensate. The addition of viscose, or hydrophilic fiber, softens the substrate and allows for better wetting of the applied cleaning solution. This enhances user experience and increases efficiency.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A wipe comprising a fibrous substrate and an aqueous composition impregnated therein, wherein:
the fibrous substrate comprises oleophilic fibers and hydrophilic fibers in amounts within a weight ratio range of 10:90 to 90:10; and
the aqueous composition comprises:
greater than 0 wt-% and up to 50 wt-% of a silicate;
a non-zwitterionic anionic silane;
a zwitterionic silane; and
water;
wherein the weight percent of silicate is based on the total weight of silane(s) plus silicate(s) solids in the composition.

2. The wipe of claim 1 wherein the zwitterionic silane comprises a zwitterionic sulfonate-functional silane, a zwitterionic carboxylate-functional silane, a zwitterionic phosphate-functional silane, a zwitterionic phosphonic acid-functional silane, a zwitterionic phosphonate-functional silane, or a combination thereof.

3. The wipe of claim 2 wherein the zwitterionic silane has the following formula (Formula II):
(R¹O)ₚ—Si(Q¹)_{q}—W—N⁺(R²)(R³)—(CH₂)ₘ—Z^{t-} (II)
wherein:
each R¹ is independently a hydrogen, methyl group, or ethyl group;
each Q¹ is independently selected from hydroxyl, alkyl groups containing from 1 to 4 carbon atoms, and alkoxy groups containing from 1 to 4 carbon atoms;
each R² and R³ is independently a saturated or unsaturated, straight chain, branched, or cyclic organic group, which may be joined together, optionally with atoms of the group W, to form a ring;
W is an organic linking group;
Z^{t-} is —SO₃⁻, —CO₂⁻, —OPO₃²⁻, —PO₃²⁻, —OP(═O)(R)O⁻, or a combination thereof, wherein t is 1 or 2, and R is an aliphatic, aromatic, branched, linear, cyclic, or heterocyclic group, or a combination thereof.
p and m are integers of 1 to 10;
q is 0 or 1; and
p+q=3.

4. The wipe of claim 1 wherein the zwitterionic silane is present in an amount of 0.0001 wt-% to 10 wt-%, based on the total weight of the aqueous composition.

5. The wipe of claim 1 wherein the silicate is an inorganic silicate.

6. The wipe of claim 5 wherein the silicate is selected from lithium silicate, sodium silicate, potassium silicate, or a combination thereof.

7. The wipe of claim 1 wherein the non-zwitterionic anionic silane comprises one or more associative functional groups.

8. The wipe of claim 1 wherein the non-zwitterionic anionic silane is present in an amount of 0.0001 wt-% to 10 wt-%, based on the total weight of the aqueous composition.

9. The wipe of claim 1 wherein the aqueous composition further comprises a surfactant.

10. The wipe of claim 1 wherein the substrate has a mass of at least 20 g/m² and up to 140 g/m².

11. The wipe of claim 1 wherein the hydrophilic fibers comprise cellulose fibers, rayon fibers, cotton fibers, polyamide fibers, polyacrylic acid fibers, fibers treated with surfactant, or combinations thereof.

12. The wipe of claim 1 wherein the oleophilic fibers comprise polyurethane fibers, polypropylene fibers, polyethylene fibers, polyethylene terephthalate fibers, or combinations thereof.

13. The wipe of claim 1 wherein the oleophilic fibers and hydrophilic fibers are present in amounts within a weight ratio range of 20:80 to 80:20.

14. The wipe of claim 13 wherein the oleophilic fibers and hydrophilic fibers are present in amounts within a weight ratio range of 30:70 to 70:30.

15. The wipe of claim 14 wherein the oleophilic fibers and hydrophilic fibers are present in amounts within a weight ratio range of 40:60 to 60:40.

16. A method of coating a surface, the method comprising:
providing a wipe of claim 1; and
applying the aqueous composition to the surface; and
allowing the aqueous composition to dry on the surface.

17. The method of claim 16 which is a method of cleaning and protecting a surface and applying the aqueous composition comprises applying the aqueous composition to the surface under conditions effective to remove contaminants from the surface.

18. The method of claim 16 wherein the surface is a metallic surface.

19. The method of claim 18 wherein the metallic surface comprises stainless steel, aluminum, anodized aluminum, titanium, zinc, silver, a surface oxide thereof, or a combination thereof.

20. The method of any of claim 16 wherein the surface forms at least a portion of an article.
